(19) United States
(12) Patent Application Publication
(10) Pub. No.: US 2025/0329103 A1
(43) Pub. Date: Oct. 23, 2025

(54) METHOD FOR GENERATING THREE-DIMENSIONAL TRAINING DATA FOR A DETECTION DEVICE FOR DETECTING THREAT OBJECTS IN LUGGAGE ITEMS

(71) Applicant: SMITHS DETECTION GERMANY GMBH

(72) Inventors: Geert HEILMANN, Wiesbaden (DE); Philipp FISCHER, Oberursel (DE); Mohammad RAZAVI, Wiesbaden (DE)

(21) Appl. No.: 18/282,104

(22) PCT Filed: Mar. 14, 2022
(86) PCT No.: PCT/EP2022/056479

§ 371 Date: Aug. 21, 2024

(30) Foreign Application Priority Data
Mar. 15, 2021 (DE) 102021202511.0

(51) Int. Cl. G06T 15/08; G06V 10/774; G06V 10/82; G06V 20/52

(52) U.S. Cl. CPC G06T 15/08; G06V 10/774; G06V 10/82; G06V 20/52

(57) ABSTRACT

The disclosure relates to a method for generating three-dimensional training data for a detection device for detecting alarm objects (AO) in items of luggage (L). The method includes providing an object scan (OS) of an exempted alarm object (AO), providing a luggage scan (LS) of an item of luggage (L), combining the luggage scan (LS) and the object scan (OS) into a combination scan (CS), and generating a three-dimensional combination volume (CV) from the combination scan (CS).

### CROSS-REFERENCE TO RELATED APPLICATIONS

The present application is a national stage entry of PCT/EP2022/056479 filed on Mar. 14, 2022, which claims the benefits of DE Patent Application No. 102021202511.0 filed on Mar. 15, 2021, the contents of which are hereby incorporated by reference in their entirety.

### BACKGROUND

The present disclosure relates to a method for generating three-dimensional training data for a detection device for detecting alarm objects in items of luggage, a generation device for carrying out such a method and a corresponding computer program product.

It is known that so-called neural networks must be trained as artificial intelligence (Al) in order to provide the desired detection functions. In order to train a neural network, a large quantity of so-called labelled, i.e. marked, training data is required. Furthermore, it is also known for such trained neural networks to be used for the detection of alarm objects in items of luggage. It is also known for training data in the form of training images to be integrated into the day-to-day control procedure of the operating personnel at security gates in order to monitor the operating personnel and keep their level of attentiveness high.

The problem with the known solutions is to provide a high and significant amount of training data. This is usually only the case with two-dimensional training data. In order to provide a large amount of training data, it is known for these to be generated generically. In principle, this works relatively well with two-dimensional training data. However, if three-dimensional training data is generated generically, in particular by combining exempted objects with real luggage scans, this leads, in combination, to unrealistic three-dimensional combination volumes which are not suitable for training a neural network and/or monitoring the operating personnel at a security gate. This is due in particular to the fact that corresponding optical artifacts, such as would be created in the real detection of objects in a three-dimensional object scan, are not provided in the known generic generation. Thus, it has not so far been possible to provide three-dimensional training data for neural networks in a quality that is so realistic that a reasonable and specific training of the neural networks and/or monitoring of the operating personnel is possible.

As already explained, in addition to training neural networks, it is also known for manual training data to be generated which is used during operation on the security belt of an airport in order to monitor the currently active operating personnel and to check whether an alarm object would be detected. The known solutions make it possible to integrate two-dimensional objects into a two-dimensional combination scan and in this way create a virtual alarm situation for the operating personnel. This has not so far been possible with three-dimensional monitoring solutions, since the realism of such virtual alarm situations is not sufficient to be perceived as realistic by the operating personnel at a security gate.

### BRIEF DESCRIPTION

The present disclosure remedies the disadvantages described above. In particular, the present disclosure automatically generates training data in a cost-effective and simple manner with high quality and/or realistic representation.

This is achieved by a method with the features of claim 1, a generation device with the features of claim 11 and a computer program product with the features of claim 14. Further features and details of the disclosure are disclosed in the dependent claims, the description and the drawings. Naturally, features and details described in connection with the method according to the disclosure also apply in connection with the generation device according to the disclosure and the computer program product according to the disclosure and vice versa, so that, with regard to disclosure, mutual reference is or can always be made to the individual aspects of the disclosure.

According to the disclosure, a method for generating three-dimensional training data for a detection device for detecting alarm objects in items of luggage is provided. For this purpose, the method includes the following steps:
providing an object scan of an exempted alarm object,
providing a luggage scan of an item of luggage,
combining the luggage scan and the object scan into a combination scan,
generating a three-dimensional combination volume from the combination scan.

A method according to the disclosure is based on the basic procedure for a detection device in use at a security gate. For example, inspection scans are often made available there which are for example generated by a rotating scanning module. For example, if electromagnetic beams are used, these can be transmitted from an emitter to a co-rotating detector, resulting in rotating inspection images. These inspection images in the image plane are then converted algorithmically into a three-dimensional inspection volume so that the corresponding evaluation and/or display for the operating personnel at a security gate can be carried out in a three-dimensional manner.

In the context of the present disclosure, the inspection scan, the object scan, the luggage scan and/or the combination scan are in particular a combination of several transmission scans. These individual transmission scans can be either one-dimensional or two-dimensional.

According to the disclosure, the combination of an item of luggage with an alarm object is now carried out on the two-dimensional plane. To make this possible, two initial pieces of information are necessary. On the one hand, this involves an object scan of an exempted alarm object. In principle, it is conceivable to provide a large number of such object scans, for example in the form of a database. It is for example possible to record such an object scan of an exempted alarm object by scanning the alarm object individually, i.e. independently of an item of luggage, with a corresponding scanning module. This can be the case for different orientations of an alarm object, but also for different alarm objects. Alarm objects can for example be undesirable materials, for example explosives, but also undesirable objects, for example in the form of weapons.

In addition to the first basic piece of information in the form of the object scan, a luggage scan is required as the second basic piece of information. It is irrelevant for the functionality of a method according to the disclosure whether this luggage scan is also provided from a database or whether it represents an item of luggage that is actually currently being examined in the security gate during ongoing operation at a security gate. Here too, a database can provide a large number of scans of different items of luggage easily and inexpensively.

According to the disclosure, a combination of the object scan and the luggage scan on a two-dimensional plane is now provided in a subsequent step. This combination can basically be achieved by superimposing the object scan and the luggage scan. For example, when using electromagnetic radiation, the corresponding individual pixel information, which is generated on the basis of physical conditions through the absorption of the corresponding objects or contents of a piece of luggage, can be superimposed. Thus colour information, but also brightness information, for example in the form of a material luminescence image, can be integrated into the combination scan for the object scan and for the luggage scan.

The result of this combination step is a combination scan which has integrated the object scan into the luggage scan. This combination scan corresponds to a real scan carried out in a security gate, in which such an object is recorded in an item of luggage. Similarly to a real situation at a security gate, this combination scan is now subjected to a generation step which generates a three-dimensional combination volume. This three-dimensional combination volume is now generated on the basis of a realistic combination scan, so that the optical artifacts and defects resulting from the generation of the three-dimensional combination volume occur in the same way they would occur with a real object in a real item of luggage.

Based on the above explanation, it can be seen that the core idea according to the disclosure significantly increases the realism of the generation step of the three-dimensional combination volume. In particular, this makes it possible to provide three-dimensional combination volumes which can then form the three-dimensional training data. In a first step, it is irrelevant whether the three-dimensional combination volume is a single item of three-dimensional training data for the use of a security gate to monitor the operating personnel or whether it is to be used in large quantities for the automated training of a neural network.

According to the disclosure, it is thus possible in this way to provide training data in a three-dimensional manner with a high degree of realism, since the step of generating the three-dimensional combination volume is carried out in a similar way to that in a real detection situation. In contrast to the known solutions, this makes it possible to generate individual, but also a large number of three-dimensional training data easily, cost-effectively and quickly. The three-dimensional training data thereby consist of a combination of voxels within the corresponding combination volume which can then be made available, for example as an inspection volume, for corresponding evaluation steps.

It can be advantageous if, in a method according to the disclosure, the object scan and/or the luggage scan have individual scanning sections, in particular a sinogram. These individual scanning sections of the object scan and/or the luggage scan may be also arranged in a corresponding underlying database of scans. Individual scanning sections may consist of video sequences, section-by-section images or frames of corresponding recordings. This allows the generation of the object scan and the luggage scan to be carried out in a simple and, above all, known manner. It is also possible to make use of existing luggage scans and/or object scans, which can be used as a basis for generating three-dimensional training data using a method according to the disclosure.

It is also advantageous if, in a method according to the disclosure, the object scan and the luggage scan are provided in the same or substantially identical form, in particular in the form of sinograms. The identical form of the object scan and the luggage scan makes it even easier to combine them with the combination scan. In particular, this makes it unnecessary to carry out an adjustment or correlation of different forms of object scan and luggage scan. In the simplest way, a mathematical addition of the object scan and luggage scan can be provided. A sinogram is thereby to be understood as the use of electromagnetic radiation which, for example by means of computer tomography, provides the desired object scan and the desired luggage scan. Here too, it should be pointed out once again that individual frames, images, but also video sequences can be made available through a rotation of a corresponding scanning device. As has already been explained, the object scan and luggage scan consist of a series of one-dimensional and/or two-dimensional data.

Further advantages can be achieved if, in a method according to the disclosure, a detection of the boundaries of the item of luggage is carried out with the luggage scan, whereby the object scan with the alarm object within the detected boundaries of the item of luggage is then combined with the luggage scan. While it is a fundamental core idea of the present disclosure to position the alarm object within the item of luggage, this embodiment ensures that the alarm object is actually visually located within the boundaries of the item of luggage. In other words, the method according to the disclosure is improved here in that a defined relative positioning of the alarm object in relation to the item of luggage is carried out. For example, it is possible to detect where the boundary of the respective item of luggage lies through abrupt changes in the density of the individual adjacent voxels or the individual adjacent pixels of the luggage scan. Once this boundary has been determined, the alarm object can be positioned relative to the item of luggage, within the item of luggage, in the desired way, so that unrealistic combination scans or, consequently, unrealistic combination volumes, in which the alarm object would be arranged outside of the boundaries of the item of luggage or even extending across such a boundary, can be avoided. In this way, realism and reliability can be increased even further with this embodiment. In order to carry out such relative positioning, a time offset can for example be provided which is taken into account when combining the luggage scan and the object scan. It is also conceivable that a suitable object scan is explicitly used in order, for example, to provide the combination of object scan and luggage scan transversely to a detection axis in a realistic way.

It is also advantageous if, in a method according to the disclosure, a detection of free spaces within the item of luggage is carried out in the luggage scan, whereby the object scan with the alarm object within the detected free space is then combined with the luggage scan. Similarly to the previous paragraph, this results in an even greater degree of realism, since a conflict between the existing contents of the item of luggage and the alarm object is avoided. Here too, the density of the material in each pixel of the item of luggage can provide information as to which areas of the item of luggage in the luggage scan can be defined as free space. In order to ensure a high degree of realism, in this embodiment a defined limit can also be specified or a limit value can be specified above which a free space is defined as such. In order to provide an adaptation and integration of the alarm object into the item of luggage in a realistic way, this can in turn be moved along the detection axis with a time offset during combination with the object scan. It is also conceivable to select an object scan from a corresponding database to match the corresponding free space in the item of luggage of the luggage scan.

It is also advantageous if, in a method according to the disclosure, the alarm object is positioned relative to the item of luggage in that the object is offset in time. As has already been explained, luggage scans and object scans can, in particular, be provided in individual frames. Thus, it is possible to provide this time offset along a detection axis of a detection device in such a way that the alarm object can be offset with regard to its relative position along this detection axis relative to the item of luggage. Due to the frame-by-frame or section-by-section provision of the object scan, the time offset thus leads to a shift in the relative position of the alarm object in relation to the item of luggage. The corresponding sinogram or the corresponding object scan remains the same. This can be used both as an offset along the detection axis for positioning relative to the boundaries of the item of luggage, but also for positioning within a free space within the item of luggage. If no suitable positioning is possible with this method, another object scan can also be selected, for example by iteration in a method according to the disclosure, in order to ensure the desired realistic relative positioning.

It is also advantageous if, in a method according to the disclosure, a detection of areas with a material density above a specified limit value is carried out during the combination scan, whereby the areas with a material density above the limit value are combined with an adjustment factor when generating the three-dimensional combination volume. Especially in areas containing metallic components, so-called beam hardening can occur. This leads to a change in the absorption situation within the item of luggage or the alarm object. In order also to take such situations of beam hardening into account in the virtual generation of the three-dimensional training data, a corresponding adjustment factor can ensure realism at a specified limit value or when this is exceeded. When generating the three-dimensional combination volume, this adjustment factor is in particular less than 1, i.e. it reduces the corresponding parameters when generating the combination volume.

It can bring further advantages if, in a method according to the disclosure, the object scan and/or the luggage scan are selected from a scans database. This makes it possible for example, as has already been explained, to adapt suitable alarm objects to boundaries or free spaces of an item of luggage. In addition, it becomes possible to provide a high number of different possible combinations, substantially automatically, in order to provide a high number of different combination volumes and thus a high number of three-dimensional training data for the training of a neural network. In particular, this can be done iteratively in an automated manner.

It brings further advantages if, in a method according to the disclosure, at least the steps of providing the object scan, the luggage scan, the combination of the object scan with the luggage scan and the generation of the three-dimensional combination volume are carried out several times. Different object scans may be combined with different luggage scans, so that a large number of different combination volumes are generated as a result. The fact that this procedure can now be carried out automatically, in particular with the help of a corresponding scans database, means that a large number of individual three-dimensional training data can be made available for the training of an artificial intelligence in the form of a neural network. In particular, use is made of a correspondingly clear additional piece of information relating to the individual object scan indicating what exactly it is. In principle, the label of the existing alarm object can be used, but also more detailed information about which form of an alarm object has in this case currently been integrated into the combination volume. Here again it can clearly be seen how a very high number of realistic three-dimensional training data can be generated in a particularly simple, cost-effective and efficient way.

In addition, it is advantageous if, in a method according to the disclosure, the luggage scan is generated in a detection device on a real item of luggage. For example, a method according to the disclosure can be used at a real security gate to monitor the operating personnel working there. If, for example, an item of luggage is located on a conveyor belt passing through a corresponding detection device, an alarm object can be projected virtually into the real item of luggage with the help of a method according to the disclosure. Thus, the real item of luggage appears on the associated security monitor of the operating personnel with an integrated virtual alarm object. This ensures that the attentiveness of the control personnel or operating personnel can be monitored. Due to the design of the method according to the disclosure, this can be achieved with a high degree of realism, so that this training situation cannot be recognised as such by the operating personnel due to an unrealistic image.

The subject matter of the present disclosure also includes a generation device for generating three-dimensional training data for a detection device for detecting alarm objects in items of luggage. Such a generation device has a scanning module for providing an object scan of an exempted alarm object as well as providing a luggage scan of an item of luggage. Furthermore, a combination module is provided for combining the luggage scan and the object scan into a combination scan. The generation device also has a generation module for generating a three-dimensional combination volume from the combination scan. The scanning module, the combination module and/or the generation module may be designed to carry out a method according to the disclosure. Thus, a generation device according to the disclosure brings the same advantages as have been explained in detail with reference to a method according to the disclosure.

It can also be advantageous if, in a generation device according to the disclosure, the scanning module has a scans database in which a large number of object scans and/or luggage scans are stored. A combination with real items of luggage is also conceivable when using a real security gate. The use of correspondingly large databases makes it possible to provide a high number of possible combinations in order to provide the correspondingly high number of individual three-dimensional training data for the training of a neural network.

The subject matter of the present disclosure also includes a computer program product comprising instructions which, when the program is run on a computer, cause it to carry out the steps of a method according to the present disclosure.

### BRIEF DESCRIPTION OF THE DRAWINGS

Further advantages, features and details of the disclosure are explained in the following description, in which embodiments are described in detail with reference to the drawings. The features mentioned in the claims and in the description may in each case be essential to the disclosure individually or in any combination. In each case schematically:

FIG. 1 shows an embodiment of a method step according to the disclosure,

FIG. 2 shows a step of a method according to the disclosure,

FIG. 3 shows a step of a method according to the disclosure,

FIG. 4 shows a step of a method according to the disclosure,

FIG. 5 shows a step of a method according to the disclosure,

FIG. 6 shows an example of a generation device according to the disclosure and

FIG. 7 shows an example of a generation device according to the disclosure.

### DETAILED DESCRIPTION

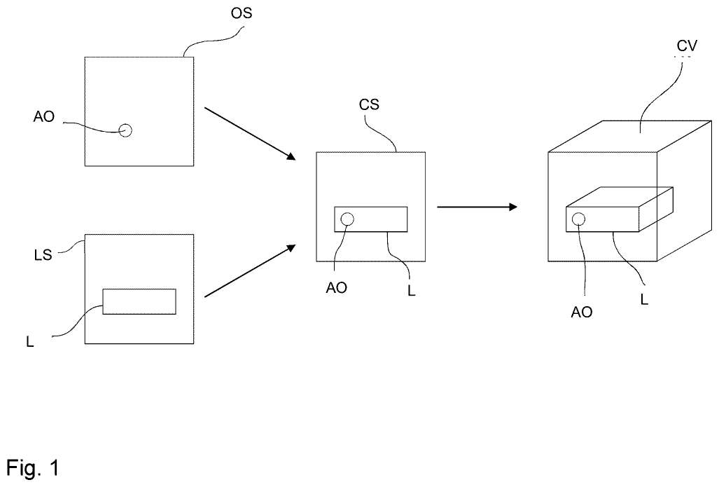

FIG. 1 shows schematically how the core idea of the present disclosure is made available. It should be noted that the object scan OS and the luggage scan LS consist of a large number of individual images which are for example composed of a combination of several transmission scans. The individual transmission scans can be one-dimensional and/or two-dimensional. An object scan OS and a luggage scan LS are provided here as a starting point. An exempted alarm object AO is provided in the object scan OS. The object scan OS can, for example, be generated in an explicit way, so that a large number of different alarm objects AO are used and scanned in a unique manner, through the use of electromagnetic scanning systems, in order to provide a large number of different object scans OS.

In the same way, it is also conceivable to scan a large number of different items of luggage L for a scans database 22 and in this way to provide a correspondingly high number of luggage scans LS.

Starting out from the provided object scans OS and luggage scans LS, these are combined in a further step to form a combination scan CS. As can clearly be seen schematically in FIG. 1, the alarm object AO is integrated into the item of luggage L through this combination. Only then, i.e. after the combination, is this combination of item of luggage L and alarm object AO transferred into a three-dimensional combination volume CV in a generation step. Within this three-dimensional combination volume CV, the alarm object AO remains located in the item of luggage L. This three-dimensional combination volume CV can now be used to monitor the operating personnel of a detection device 100, but also, in corresponding numbers, for training neural networks.

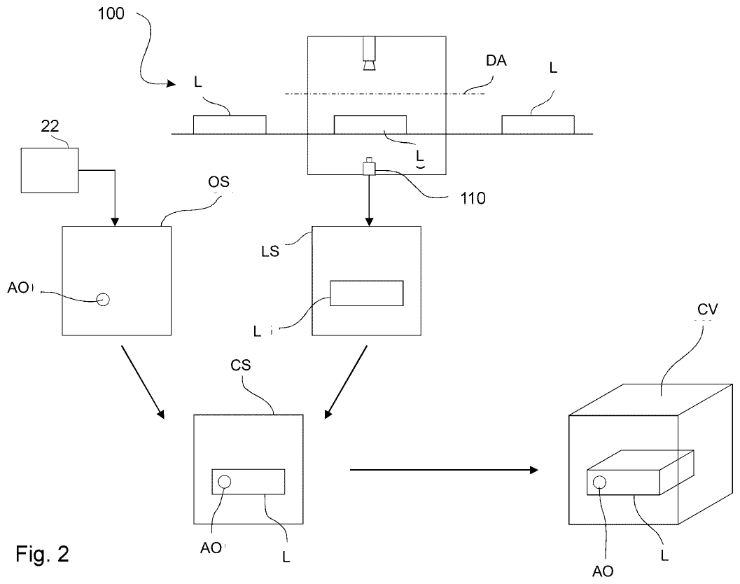

FIG. 2 shows a schematic arrangement for training or monitoring operating personnel at a real security gate. Here, a detection device 100 is shown schematically which can provide luggage scans LS of real items of luggage L using electromagnetic radiation by means of a scanning module 110. The items of luggage L move along a detection axis DA. For example, it is possible that the scanning module 110 rotates around this detection axis DA and in this way generates rotating luggage scans LS. In this embodiment shown in FIG. 2, the object scan OS is provided from a scans database 22. Similarly to FIG. 1, a combination scan CS is now generated from the real luggage scan LS and the object scan OS provided virtually from the database 22. Again similarly to FIG. 1, a combination volume CV is then generated, which is displayed, for example on the monitor, to the operating personnel of the real security gate for monitoring purposes or for training purposes.

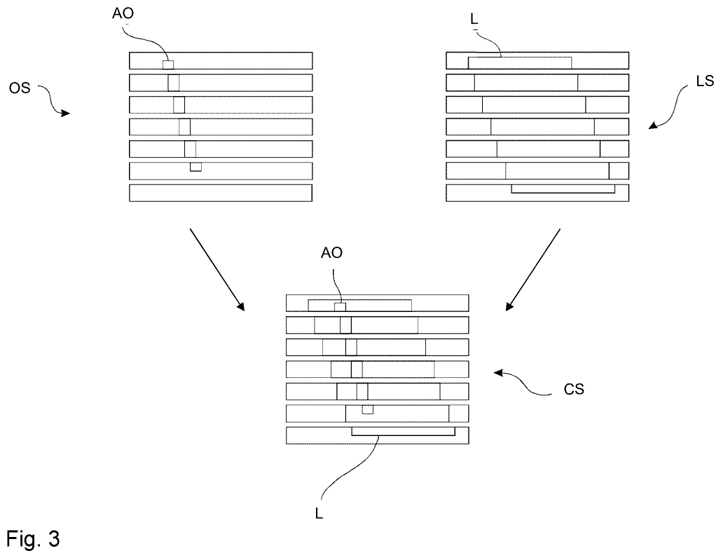

FIG. 3 shows schematically how the individual object scans OS and luggage scans LS or combination scans CS can be built up slice by slice or section by section. For example, FIG. 3 shows schematically a section-by-section representation of a sinogram for an object scan OS and, accordingly, for a luggage scan LS. Through simple addition or combination, the object scan OS and the luggage scan LS are now combined section by section to form a common combination scan CS. This is a particularly simple and cost-effective variant for providing the combination scan CS.

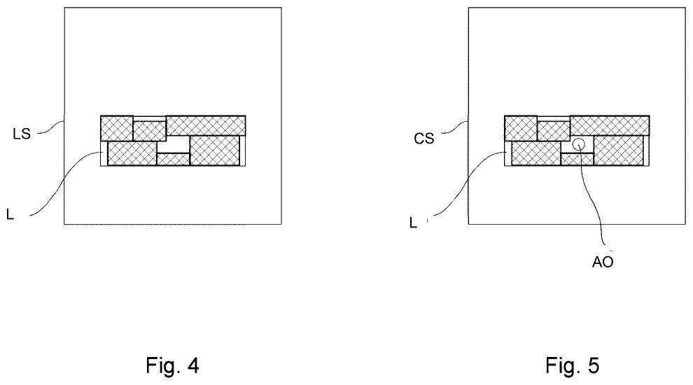

FIGS. 4 and 5 show clearly how a relative positioning of the alarm object AO and the item of luggage L can be achieved. For example, FIG. 4 shows an empty item of luggage L on a luggage scan LS. FIG. 5 shows the corresponding combination scan CS, whereby an alarm object AO has now been integrated into the item of luggage L. However, in an intermediate step, it was determined where there is a free space within the item of luggage L, so that the alarm object AO was shifted into the detected free space through a time offset of the object scan OS during the combination. This leads to a much more realistic representation and, in particular, to the avoidance of undesirable conflicts of position.

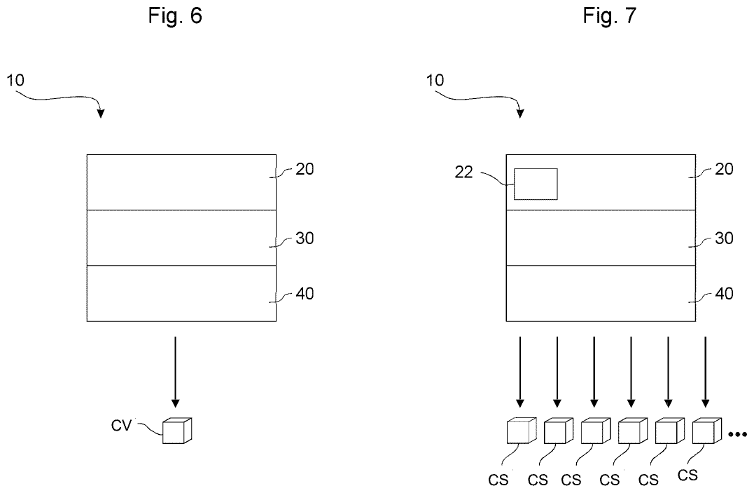

FIG. 6 shows schematically how a generation device 10 according to the disclosure may be designed. The individual scans LS and OS are provided here via a scans module. The combination module 30 generates the combination scan CS, the generation module 40 then generating the combination volume CV. It can be seen from FIG. 7 that these can also be made available in large numbers in an automated manner by making use of a scans database 22. In this way, it is possible to generate a high number of combination volumes CV which then provides, in high numbers, a three-dimensional training dataset for the training of a neural network.

The above explanation describes the present disclosure exclusively in the context of examples. Naturally, individual features of the embodiments can, where technically expedient, be combined freely with each other without departing from the scope of the present disclosure.

1. A method for generating three-dimensional training data for a detection device for detecting alarm objects (AO) in items of luggage (L), comprising:
providing an object scan (OS) of an exempted alarm object (AO),
providing a luggage scan (LS) of an item of luggage (L),
combining the luggage scan (LS) and the object scan (OS) into a combination scan (CS), and
generating a three-dimensional combination volume (CV) from the combination scan (CS).

2. The method according to claim 1, wherein the object scan (OS) and/or the luggage scan (LS) comprise individual scanning sections, in particular a sinogram.

3. The method according to claim 1, wherein the object scan (OS) and the luggage scan (LS) are provided in the same or substantially identical form, in particular in the form of sinograms.

4. The method according to claim 1, wherein, during the luggage scan (LS), a detection of the boundaries of the item of luggage (L) is carried out, wherein the object scan (OS) with the alarm object (AO) within the detected boundaries of the item of luggage (L) is then combined with the luggage scan (LS).

5. The method according to claim 1, wherein, during the luggage scan (LS), a detection of free spaces within the item of luggage (L) is carried out, wherein the object scan (OS) with the alarm object (AO) within the detected free space is then combined with the luggage scan (LS).

6. The method according to claim 1, wherein one the alarm object (AO) is positioned relative to the item of luggage (L) in that the object scan (OS) is offset in time.

7. The method according to claim 1, wherein one a detection of areas with a material density above a specified limit value is carried out during the combination scan (CS), whereby the areas with a material density above the limit value are combined with an adjustment factor when generating the three-dimensional combination volume (CV).

8. The method according to claim 1, wherein one the object scan (OS) and/or the luggage scan (LS) are selected from a scans database .

9. The method according to claim 1, wherein one at least providing the object scan (OS) and the luggage scan (LS), the combination of the object scan (OS) with the luggage scan (LS) and the generation of the three-dimensional combination volume (CV) are carried out several times.

10. The method according to claim 1, wherein the preceding claims, characterised in that the luggage scan (LS) is generated in a detection device on a real item of luggage (L).

11. A generation device for generating three-dimensional training data for a detection device for detecting alarm objects (AO) in items of luggage (L), comprising a scans modulefor providing an object scan (OS) of an exempted alarm object (AO) and providing a luggage scan (LS) of an item of luggage (L), also comprising a combination module (30) for combining the luggage scan (LS) and the object scan (OS) to generate a combination scan (CS), and a generation module (40) for generating a three-dimensional combination volume (CV) from the combination scan (CS).

12. (canceled)

13. The generation device according to claim 11, wherein the scans module (20) has a scans database (22) in which a large number of object scans (OS) and/or luggage scans (LS) are stored.

14. A computer program product comprising commands which, when the program is run by a computer, cause it to carry out the steps of a method having the features of claim 1.
